(19) United States
(12) Patent Application Publication
(10) Pub. No.: US 2013/0050037 A1
(43) Pub. Date: Feb. 28, 2013

(54) ANTENNA APPARATUS AND WIRELESS COMMUNICATION APPARATUS USING THE SAME

(71) Applicants: Nobuyasu TAKEMURA, Yokohama-City (JP); Tsutomu Mitusi, Yokohama-City (JP); Hitoyuki Arai, Yokohama-City (JP)

(72) Inventors: Nobuyasu TAKEMURA, Yokohama-City (JP); Tsutomu Mitusi, Yokohama-City (JP); Hitoyuki Arai, Yokohama-City (JP)

(73) Assignees: Yokohama National University; Samsung Electronics Co., Ltd

(21) Appl. No.: 13/596,519

(22) Filed: Aug. 28, 2012

(30) Foreign Application Priority Data
Aug. 29, 2011 (JP) 10-2011-186157
Aug. 27, 2012 (KR) 10-2012-0093933

(51) Int. Cl. H01Q 19/18; H01Q 19/185; H01Q 19/02

(52) U.S. Cl. 343/756; 343/837; 343/833

(57) ABSTRACT

A small-sized antenna apparatus capable of two-dimensionally controlling directivity, and a wireless communication apparatus mounted with the same. The antennal apparatus includes a substantially rectangular patch antenna, a plurality of parasitic devices disposed around each side of the patch antenna, and a converting unit configured to switch an electrical length of each of the plurality of parasitic devices. The converting unit controls the electric length to be switched so that the parasitic devices serve as reflectors.

### CROSS-REFERENCE TO RELATED APPLICATIONS

This application claims priority under 35 U.S.C. §119(a) from Japanese Patent Application No. 2011-186157, filed on Aug. 29, 2011, in the Japanese Patent Office, and Korean Patent Application No. 10-2012-0093933, filed on Aug. 27, 2012, in the Korean Intellectual Property Office the contents of which are incorporated herein by reference in its entirety.

### BACKGROUND OF THE INVENTION

1. Field of the Invention

The present general inventive concept relates to an antenna apparatus and a wireless communication apparatus using the same.

2. Description of the Related Art

In antenna apparatuses used in mobile communication base stations, a multiple input multiple output (MIMO) function or a variable directivity function is required to increase communication capacity. In general, variable directivity of the antenna apparatus is performed through a plurality of a plurality of antennas and thus a circuit configuration of the antenna becomes complicate.

Further, the mobile communication base stations need to be miniaturized and thus the antenna apparatuses need to be miniaturized. A conventional antenna apparatus having variable directivity and miniaturization is disclosed in Japanese Patent Publication No. 2008-219574. In the antenna apparatus, parasitic devices are disposed at both ends of λ/4 short-circuit microstrip antenna and variable directivity is performed by ON/OFF of switches connected to the parasitic devices.

However, in the λ/4 short-circuit microstrip antenna, the variable directivity is performed using parasitic devices disposed at both ends of a power supply device. However, a variable direction of directivity is limited to one dimensional direction. In the λ/4 short-circuit microstrip antenna, the λ/4 short-circuit microstrip antenna and the parasitic devices may be three-dimensionally configured to be miniaturized.

### SUMMARY OF THE INVENTION

The present general inventive concept provides an antenna apparatus which improves variable direction of directivity and implements miniaturization and a wireless communication apparatus mounted with the same.

Additional aspects and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an antenna apparatus capable of two-dimensionally vary directivity and miniaturizing a dimension thereof. The antenna apparatus may include a patch antenna having a plurality of sides, a plurality of parasitic devices disposed around each side of the patch antenna, a converting unit configured to switch an electrical length of each of the plurality of parasitic devices. The converting unit may allow the electric length to be switched so that the parasitic devices serve as reflectors. For example, the converting unit may switch the electrical length of the parasitic device substantially parallel to one side of the patch antenna and may control the parasitic devices to operate as the reflector so that directivity of the antenna is directed to a direction opposite to the parasitic devices. Alternatively, the converting unit may control the parasitic devices to operate as a director so that the directivity of the antenna is directed to the parasitic devices. In the antenna, since the parasitic devices are disposed around each side of the patch antenna, there are at least four parasitic devices when the patch antenna is a substantially rectangular patch antenna. The at least four parasitic devices may be controlled to operate as directors or reflectors such that the directivity is controlled two-dimensionally.

Further, the converting unit may be configured to switch the electrical length so that the parasitic devices operate as directors. Like the above-described configuration, the converting unit may be configured to appropriately control the electric lengths of the parasitic devices so that the parasitic devices operate as reflectors or directors.

Each of the parasitic devices may be configured of a metal wire having one long side substantially parallel to one side of the patch antenna and two short sides, one end of each of the short sides is connected to an end of the long side and the other end thereof is a ground conductor. The parasitic devices are configured of the metal wire so that the antenna apparatus can be miniaturized.

The converting unit may include a first switch provided around a center portion of the long side and configured to divide the long side in an OFF state and two second switches configured to divide the short sides in the OFF state. The converting means may be configured that in a state in which the first and second switches are ON, the length of the metal wire may be longer than a length of ½ of a wavelength in a resonant frequency of the patch antenna, and in a state in which the first switch is ON and the second switches are OFF, the length of the metal wire may be shorter than the length of ½ of the wavelength in the resonant frequency of the patch antenna. The parasitic devices may be operates as reflectors or directors through switching of the switches.

The parasitic device may set a direction substantially parallel to one side of the patch antenna as a longitudinal direction and may be formed of a conductive thin plate laminated on a dielectric substrate in which the patch antenna is installed. In this case, the converting unit may be formed on a central portion of the conductive thin plate. The antenna apparatus may have a lower height to be further miniaturized.

Each of the parasitic devices may include a first conductive thin plate in which a direction substantially parallel to one side of the patch antenna is set to a longitudinal direction, and a second conductive thin plate which is disposed farther the one side of the patch antenna than the first conductive thin plate and in which a direction substantially parallel to the one side of the patch antenna is set to a longitudinal direction. In this case, the switching device may be formed in a central portion of the conductive thin plate. The antenna apparatus may have a lower height to be further miniaturized.

The converting unit may be a switch configured to divide the conductive thin plate, for example, in an OFF state. The converting unit may be configured that in an ON state of the switch, the length of the conductive thin plate may be longer than a length of ½ of a wavelength in a resonant frequency of the patch antenna. The parasitic devices may operate as reflectors or directors through switching of the switches.

Each of the parasitic devices may be configured of two L-shaped metal wires. The parasitic device may be configured that one end of the L-shaped metal wire may penetrate a dielectric substrate in which the patch antenna is installed and may be connected to the converting unit provided on a rear surface of the dielectric substrate. By the above-described configuration, since the converting unit is provided on the rear surface of the dielectric substrate, a height of the antenna apparatus can be more reduced and thus it can contribute to further miniaturization.

Alternatively, the switching device may be a switch which connects the two L-shaped metal wires in an ON state and divides the two L-shaped metal wires in an OFF state. Further, a total length of the two L-shaped metal wires may be set to be longer than a length of ½ of a wavelength in a resonant frequency of the patch antenna. The parasitic devices may operate as reflectors or directors through ON/OFF of the switches.

The foregoing and/or other aspects and utilities of the present general inventive concept may also be achieved by providing a wireless communication apparatus including an antenna apparatus described above and a controller configured to control the converting unit.

and

The foregoing and/or other features and utilities of the present general inventive concept may be achieved by providing an antenna apparatus including a patch antenna, a plurality of parasitic devices disposed around the patch antenna, and a converting unit configured to change an electrical length of each of the plurality of parasitic devices with respect to a resonant frequency of the patch antenna to control the parasitic devices to operate one of a reflector and a director to affect directivity of the patch antenna.

The patch antenna may include comprises a plurality of sides, and the plurality of parasitic devices may be disposed corresponding sides of the patch antenna.

Each of the plurality of parasitic devices may include a plurality of sections, and the converting unit may electrically connect or disconnect the adjacent sections of the parasitic device to control the parasitic devices to operate as the reflector or the director.

The plurality of parasitic devices may include a first pair of at least two parasitic devices disposed opposite to each other in a first direction with respect to the patch antenna, and a second pair of at least two parasitic devices disposed opposite to each other in a second direction with respect to the patch antenna.

The plurality of parasitic devices may include one of a metal wire having a center portion spaced apart from a dielectric substrate and two ends extended from the center portion and disposed on the dielectric substrate, a laminated thin plate disposed on the dielectric substrate, a metal wire having a potion spaced apart from the dielectric substrate and one end extended from the portion and disposed on the dielectric substrate, and a metal foil disposed on a protruding portion of the dielectric substrate.

The foregoing and/or other features and utilities of the present general inventive concept may be achieved by providing a wireless communication apparatus including the above-describe antenna apparatus, a functional unit to process data received from an external device through the antenna apparatus or transmitted to the external device through the antenna apparatus, and a controller to control the functional unit and the antenna apparatus.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1A is a view illustrating an antenna apparatus according to an exemplary embodiment of the present general inventive concept;

FIG. 1B is a view illustrating a parasitic device according to an exemplary embodiment of the present general inventive concept;

FIG. 2 is a view illustrating an example of a switching operation of a switch of a parasitic device according to an exemplary embodiment of the present general inventive concept;

FIG. 3 is a graph illustrating a variable radiation characteristic of an antenna apparatus according to an exemplary embodiment of the present general inventive concept;

FIG. 4A is a view illustrating a switching operation of a switch of a parasitic device in an antenna apparatus according to an exemplary embodiment of the present general inventive concept;

FIG. 4B is a view illustrating a variable state of directivity according to the switching operation of FIG. 4A according to an exemplary embodiment of the present general inventive concept;

FIG. 5A is a view illustrating a switching operation of a switch of a parasitic device in an antenna apparatus according to an exemplary embodiment of the present general inventive concept;

FIG. 5B is a view illustrating a variable state of directivity according to the switching operation of FIG. 5A according to an exemplary embodiment of the present general inventive concept;

FIG. 6A is a view illustrating a switching operation of a switch of a parasitic device in an antenna apparatus according to an exemplary embodiment of the present general inventive concept;

FIG. 6B is a view illustrating a variable state of directivity according to the switching operation of FIG. 6A according to an exemplary embodiment of the present general inventive concept;

FIG. 7A is a perspective view illustrating an antenna apparatus according to an exemplary embodiment of the present general inventive concept;

FIG. 7B is a perspective view illustrating a parasitic device of the antenna apparatus of FIG. 7A according to an exemplary embodiment of the present general inventive concept;

FIG. 8 is a perspective view illustrating an antenna apparatus according to an exemplary embodiment of the present general inventive concept;

FIG. 9A is a plan view illustrating the antenna apparatus of FIG. 8 according to an exemplary embodiment of the present general inventive concept;

FIG. 9B is an enlarged view of a portion A of the antenna apparatus of FIGS. 8 and 9A according to an exemplary embodiment of the present general inventive concept;

FIG. 10A is a view illustrating a switching operation of a switch of the parasitic device in the antenna apparatus of FIG. 8 according to an exemplary embodiment of the present general inventive concept;

FIG. 10B is a view illustrating a switching operation of a switch of the parasitic device in the antenna apparatus of FIG. 8 according to an exemplary embodiment of the present general inventive concept;

FIG. 11 is a view illustrating a variable state of directivity corresponding to a switching operation of a switch of the parasitic device in the antenna apparatus of FIG. 8 according to an exemplary embodiment of the present general inventive concept;

FIG. 12A is a view illustrating an antenna apparatus according to an exemplary embodiment of the present general inventive concept;

FIG. 12B is a plan view illustrating the antenna apparatus of FIG. 12A according to an exemplary embodiment of the present general inventive concept;

FIG. 12C is a bottom view illustrating the antenna apparatus of FIG. 12A according to an exemplary embodiment of the present general inventive concept;

FIG. 13A is a view illustrating a switch of the antenna apparatus of FIG. 12A according to an exemplary embodiment of the present general inventive concept;

FIG. 13B is a view illustrating a switch of the antenna apparatus of FIG. 12A according to an exemplary embodiment of the present general inventive concept;

FIG. 14 is a view illustrating an operation of the antenna apparatus of FIG. 12A according to an exemplary embodiment of the present general inventive concept;

FIG. 15A is a view illustrating an operation of the antenna apparatus of FIG. 12A according to an exemplary embodiment of the present general inventive concept;

FIG. 15B is a view illustrating a radiation characteristic of the antenna apparatus corresponding to the operation of FIG. 15A according to an exemplary embodiment of the present general inventive concept;

FIG. 16A is a view illustrating an operation of the antenna apparatus of FIG. 12A according to an exemplary embodiment of the present general inventive concept;

FIG. 16B is a view illustrating a radiation characteristic of the antenna apparatus corresponding to the operation of FIG. 16A according to an exemplary embodiment of the present general inventive concept;

FIG. 17A is a view illustrating an operation of the antenna apparatus of FIG. 12A according to an exemplary embodiment of the present general inventive concept;

FIG. 17B is a view illustrating a radiation characteristic of the antenna apparatus corresponding to the operation of FIG. 17A according to an exemplary embodiment of the present general inventive concept;

FIG. 18 is a view illustrating an operation of the antenna apparatus of FIG. 12A according to an exemplary embodiment of the present general inventive concept;

FIG. 19A is a view illustrating an operation of the antenna apparatus of FIG. 12A according to an exemplary embodiment of the present general inventive concept;

FIG. 19B is a view illustrating a radiation characteristic of the antenna apparatus corresponding to the operation of FIG. 19A according to an exemplary embodiment of the present general inventive concept;

FIG. 20A is a view illustrating an operation of the antenna apparatus of FIG. 12A according to an exemplary embodiment of the present general inventive concept;

FIG. 20B is a view illustrating a radiation characteristic of antenna apparatus corresponding to the operation of FIG. 20A according to an exemplary embodiment of the present general inventive concept;

FIG. 21A is a view illustrating an operation of the antenna apparatus of FIG. 12A according to an exemplary embodiment of the present general inventive concept;

FIG. 21B is a view illustrating a radiation characteristic of the antenna apparatus corresponding to the operation of FIG. 21A according to an exemplary embodiment of the present general inventive concept;

FIG. 22 is a view illustrating a variant example of an operation of the antenna apparatus of FIG. 12A according to an exemplary embodiment of the present general inventive concept; and

FIG. 23 is a view illustrating a wireless communication apparatus having an antenna apparatus according to an exemplary embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

Hereinafter, an apparatus 100 according to an exemplary embodiment of the present general inventive concept will be described with accompanying drawings.

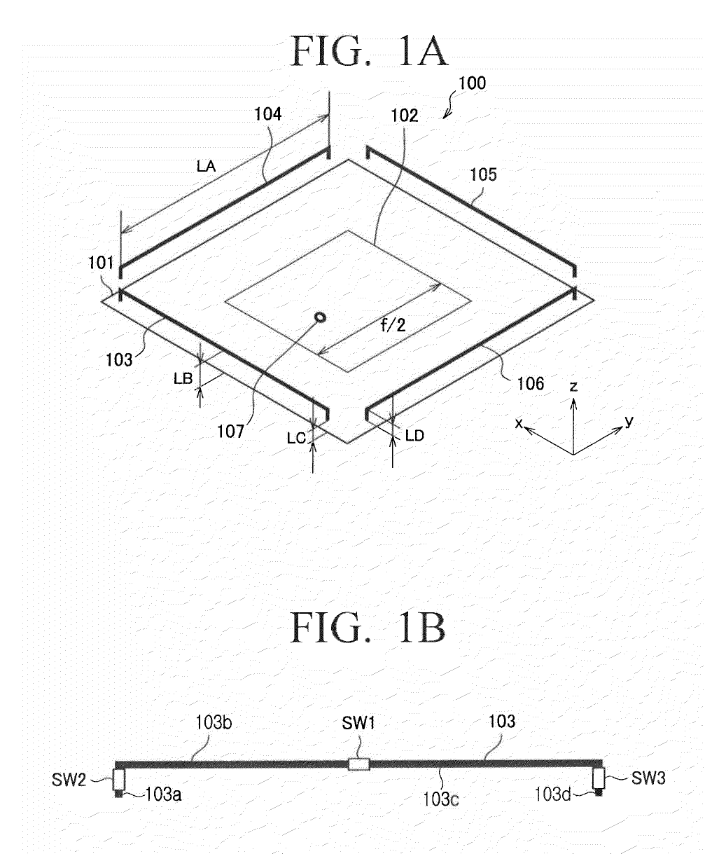

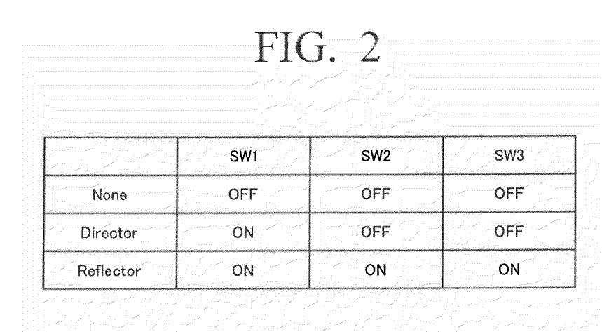

FIG. 1A is a perspective view illustrating the antenna apparatus 100 according to an exemplary embodiment of the present general inventive concept. As illustrated in FIG. 1A, the antenna apparatus 100 includes a ground conductor 101, a patch antenna 102, and parasitic devices 103, 104, 105, and 106. The parasitic devices 103, 104, 105, and 106 may be a non-power supply device. That is, parasitic devices 103, 104, 105, and 106 may not be supplied with power to perform functions thereof in the antenna apparatus 100. For example, the parasitic devices 103 to 106 may be configured of a metal wire. Further, a conductor, such as iron (Fe) or aluminum (Al), may be used as a material of the metal wire. The parasitic devices are spaced apart from the patch antenna 102 by a distance and from an edge side of the ground conductor 101 by another distance which may be shorter than the distance.

The patch antenna 102 may have a shape having a plurality of sides. The patch antennal 102 may be a rectangular shape and is disposed on the ground conductor 101. It is possible that a spacer (not illustrated) is disposed between the patch antennal 102 and the ground conductor. In the patch antenna 102, a power supply point 107 is provided at a position in which a detection direction is regulated. Further, the patch antenna 102 is connected to the ground conductor 101 via the power supply point 107. The ground conductor 101 and the patch antenna 102 may have dimensions and sizes to be determined according to a design and preference. For example, the ground conductor 101 may be determined as a square in which one side has a length of 50 mm and the patch antenna 102 may be determined as a square in which one side has a length of 24.4 mm.

The parasitic devices 103 to 106 are disposed around each side of the patch antenna 102 and provided on the ground conductor 101. Further, switches are provided on three locations, that is, approximately a central portion and both ends of each of the parasitic devices 103 to 106. For example, a configuration of the switch provided in the parasitic device 103 is illustrated in FIG. 1B. As illustrated in FIG. 1B, switches SW1, SW2, and SW3 are provided on three locations of the parasitic device 103 to connect corresponding sections 103a, 103b, 103c, and 103d. The parasitic device 103 may have a plurality of gaps to correspond to the respective switches SW1, SW2, and SW3. By an ON/OFF operation of the switches SW1, SW2, and SW3, the corresponding gap provided on a metal wire constituting the parasitic device 103 is short-circuited/open-circuited. Further, the same switches are provided on the parasitic devices 104 to 106. The switches SW1 to SW3 may be a mechanical switch having a mechanical contact point or an electrical switch using a semiconductor device having no mechanical contact point.

A total length as a sum of long side length LA and short side lengths LDx2 of the parasitic devices 103 to 106 is set, for example, to about a half (that is, λ/2) of a wavelength λ in a resonant frequency of the patch antenna 102. As illustrated in FIG. 1A, the parasitic devices 103 to 106 are disposed so that the long side portions of the parasitic devices 103 to 106 are disposed at a position of a distance LB from the corresponding sides of the ground conductor 102 and a short side portions thereof are disposed at a position of a distance LC from the corresponding sides of the ground conductor 101. For example, the long side LA may be set to 47.2 mm, the short side LD may be set to 2.8 mm, the distance LB may be set to 5.6 mm, and the distance LC may be set to 2.8 mm. However, the dimension or arrangement of the parasitic devices 103 to 106 is not limited thereto and may be appropriately changed depending the resonant frequency of the patch antenna 102 or a size of the ground conductor 101. The antenna apparatus may have a structure (not illustrated) to support the parasitic devices 103 to 106 with respect to the ground conductor 101 and the patch antenna 102 as described above.

Therefore, the directivity of the antenna apparatus 100 according to the exemplary embodiment may be switched (or changed) by controlling the ON/OFF operation of the switches SW1, SW2, and SW3 provided on each of the parasitic devices 103 to 106. The parasitic device 103 to 106 may be changed to operate as a director or a reflector and not to operate as the director or reflector according to the ON/OFF switching operation of the switches SW1, SW2, and SW3. Therefore, by changing a combination of a director function, a reflector function, or a non-director or non-reflector function of each of the parasitic devices 103 to 106, the directivity of the antenna apparatus 100 can be switched.

Here, a relationship between an ON/OFF state of the switches SW1, SW2, and SW3 and the functions of the parasitic devices 103 to 106 will be described with reference to FIG. 2. FIG. 2 is a table illustrating the relationship between functions of the parasitic devices 103 to 106 and the ON/OFF state of the switches SW1, SW2, and SW3.

When the switches SW1, SW2, and SW3 all are in the OFF state, since the metal wires constituting the parasitic devices 103 to 106 are divided, the parasitic devices 103 to 106 are not operated as a director or a reflector. When the switch SW1 is in the ON state and the switches SW2 and SW3 are in the OFF state (that is, a central portion of the metal wire is short-circuited and both opposite ends thereof are open-circuited), an electrical length of the metal wire becomes slightly shorter than a half (that is, λ/2) of a wavelength λ in the resonant frequency of the patch antenna 102. Therefore, the parasitic devices 103 to 106 operate as a director. When the switches SW1, SW2, and SW3 all are in the ON state, the electrical length of the metal wire becomes slightly longer than λ/2. Therefore, the parasitic devices 103 to 106 operate as a reflector.

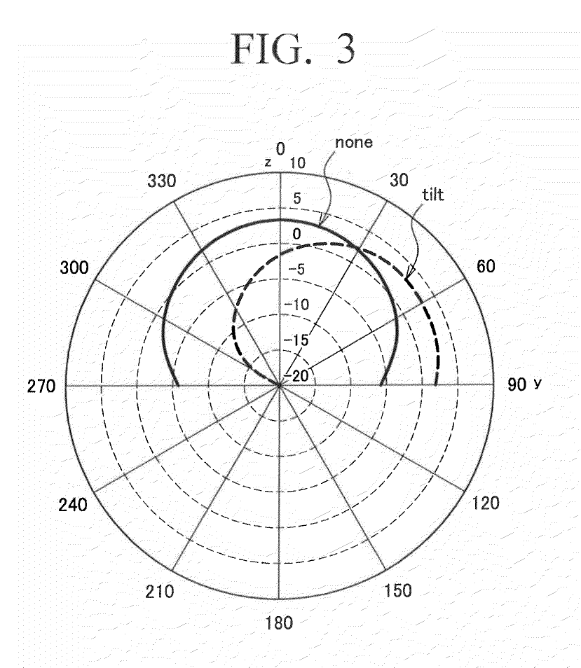

An operation of the antenna apparatus 100 according to the exemplary embodiment will be described with reference to FIGS. 3 to 6B. When the directivity of the antenna apparatus 100 according to the exemplary embodiment is switched (or changed) through a control operation (or switching operation) of the switches SW1, SW2, and SW3, for example, a pair of parasitic devices 103 and 105 are disposed to face each other with respect to the patch antenna 102 and are controlled in pair, and a pair of parasitic devices 104 and 106 are disposed to face each other and are controlled in pair. For example, the antenna apparatus 100 allows (controls) the parasitic device 104 to operate as a reflector and the parasitic device 106 to operate as a director or the antenna apparatus 100 allows (controls) the parasitic device 104 to operate as a director and the parasitic device 106 to operate as a reflector. The pair of the parasitic devices 103 and 105 are operated like the pair of parasitic device 104 and 106.

First, a relationship between a function and a radiation characteristic of the parasitic device 103 to 106 will be described with reference to FIG. 3. FIG. 3 is a graph illustrating a change of a radiation characteristic according to the control operation of the parasitic device 103 to 106.

A solid line (none) illustrated in FIG. 3 shows a radiation characteristic obtained when the switches SW1, SW2, and SW3 of the parasitic devices 103 to 106 all are in the OFF state. That is, the solid line shows a radiation characteristic when the parasitic devices 103 to 106 are not operated as a director or a reflector.

Meanwhile, a dotted line (tilt) illustrated in FIG. 3 shows a radiation characteristic obtained when the switches SW1, SW2, and SW3 of the parasitic device 103 all are in the ON state, the switch SW1 of the parasitic 105 is in the ON state and the switches SW2 and SW3 of the parasitic device 105 are in the OFF state. That is, the dotted line (tilt) shows a radiation characteristic in which antenna apparatus 100 allow the parasitic device 103 to operate as a reflector and the parasitic device 105 to operate as a director.

It can be seen from FIG. 3 that when viewed in a location of the power supply point 107, the antenna apparatus 100 allows the parasitic device 105 disposed in a y direction to operate as a director and allows the parasitic device 103 disposed in a −y direction to operate as a reflector so that the directivity is directed to a direction approaching in the y direction. When viewed in a location of the power supply point 107, the antenna apparatus 100 allows the parasitic device 105 disposed in a y direction to operate as a reflector and allows the parasitic device 103 disposed in a −y direction to operate as a director so that the directivity is directed to a direction approaching in the −y direction.

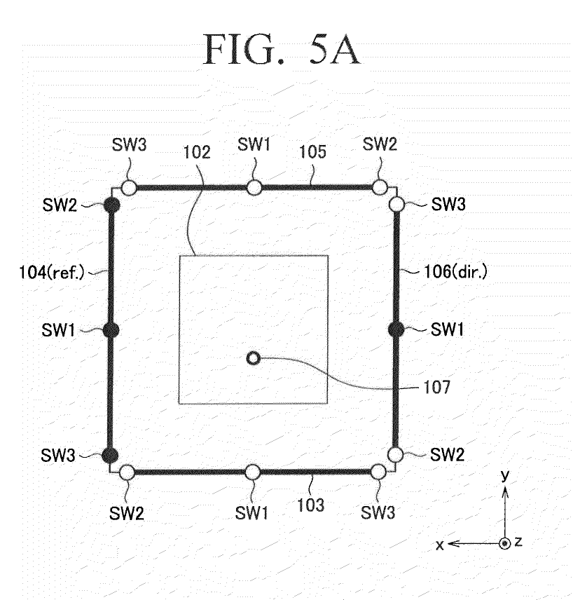

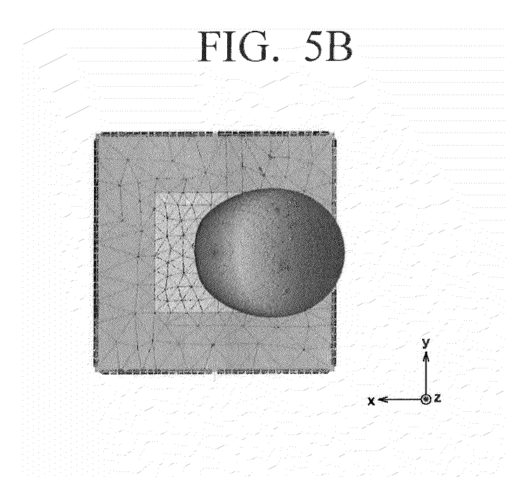

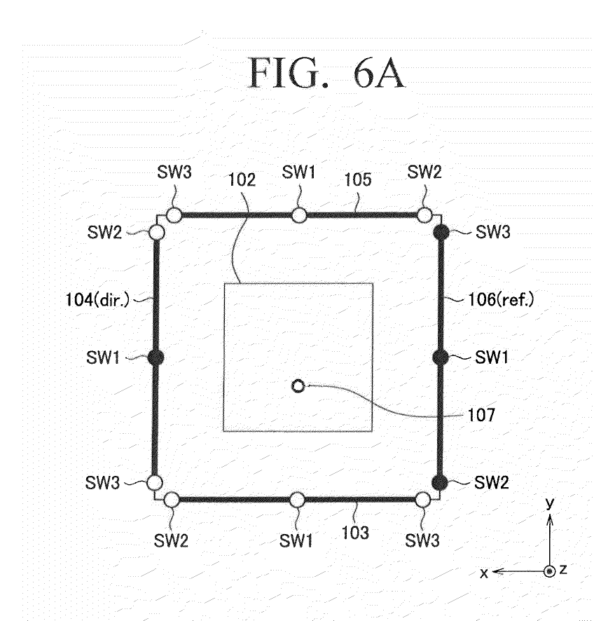

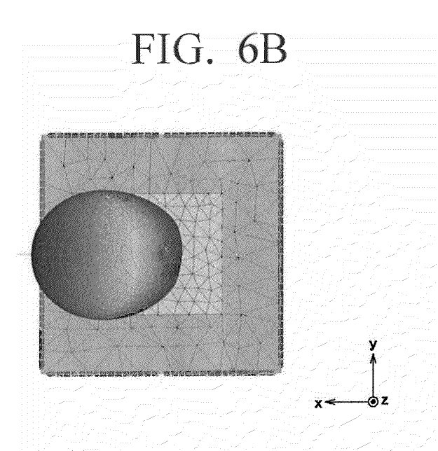

It is possible that the directivity can be directed to a direction approaching in x direction (or −x direction) by the control operation of the function of the parasitic devices 104 and 106 (see FIGS. 5A to 6B to be described later). For example, when viewed in a location of the power supply point 107, the antenna apparatus 100 allows the parasitic device 104 disposed in a x direction to operate as a director and allows the parasitic device 106 disposed in a −x direction to operate as a reflector so that the directivity is directed to a direction approaching in the x direction. Similarly, when viewed in a location of the power supply point 107, the antenna apparatus 100 allows the parasitic device 104 disposed in a x direction to operate as a reflector and allows the parasitic device 106 disposed in a −x direction to operate as a director so that the directivity is directed to a direction approaching in the −x direction.

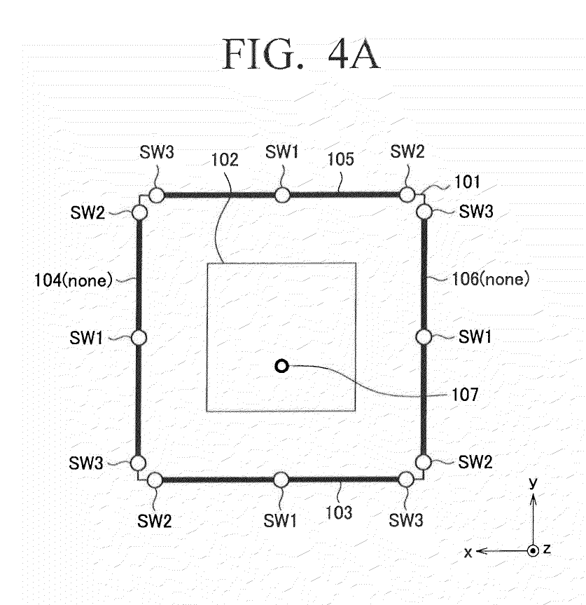

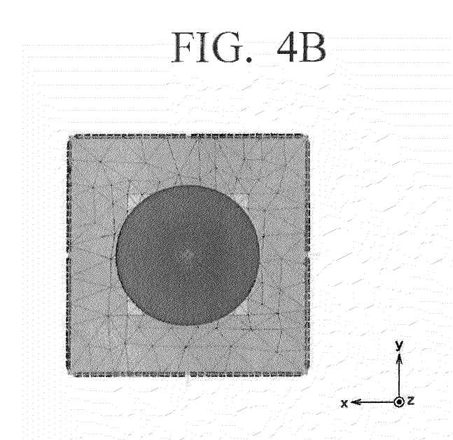

Here, a control method and an example for a change of the directivity when the directivity is directed to a direction approaching the x direction or the −x direction will be described with reference to FIG. 4A to FIG. 6B.

FIG. 4A is a view illustrating a switching operation of the parasitic devices 103 to 106. Referring to FIG. 4A, the parasitic devices 103 to 106 all are controlled to be in a state in which the parasitic devices 103-106 are not operated as either a director or a reflector. That is, all the switches SW1, SW2, and SW3 in all parasitic devices 103 to 106 are in the OFF state. The switches SW1, SW2, and SW3 are indicated by a circle. A white circle indicates an OFF state of the switch and a black circle indicates an ON state of the switch. When the functions of the parasitic devices 103 to 106 are controlled as illustrated in FIG. 4A, the radiation characteristic of the antenna apparatus 10 is not biased with respect to a direction in a x-y plane as illustrated in FIG. 4B. That is, the directivity is directed to a z direction in a three dimension.

FIG. 5A is a view illustrating a switching operation of the parasitic devices 103 to 106. Referring to FIG. 5A, the parasitic devices 103 and 105 all are controlled to be in a state in which the parasitic devices 103 and 105 are not operated as either a director or a reflector. While the parasitic devices 104 and 106 all are controlled in a state in which the parasitic devices 104 and 106 are operated as a reflector and a director, respectively. The switches SW1, SW2, and SW3 are indicated by a circle. The white circle indicates an OFF state of the switch and the black circle indicates an ON state of the switch. When the functions of the parasitic devices 103 to 106 are controlled as illustrated in FIG. 5A, that is, switches SW1, SW2, and SW3 of the parasitic device 104 are in the ON state such that the parasitic device 104 is controlled to operate as a reflector, and the switch SW1 of the parasitic device 106 is in the ON state while the switch SW2 and SW3 of the parasitic device 106 is in the OFF state such that the parasitic device 106 is controlled to operation as a director, the radiation characteristic of the antenna apparatus 10 is obtained that the directivity is directed to a direction approaching the −x direction in a three dimension as illustrated in FIG. 5B.

FIG. 6A is a view illustrating a switching operation of the parasitic devices 103 to 106. Referring to FIG. 6A, the parasitic devices 103 and 105 all are controlled to be in a state in which the parasitic devices 103 and 105 are not operated as either a director or a reflector. While the parasitic devices 104 and 106 all are controlled in a state in which the parasitic devices 104 and 106 are operated as a director and reflector, respectively. The switches SW1, SW2, and SW3 are indicated by a circle. The white circle indicates an OFF state of the switch and the black circle indicates an ON state of the switch. When the functions of the parasitic devices 103 to 106 are controlled as illustrated in FIG. 6A, that is, switches SW1, SW2, and SW3 of the parasitic device 106 are in the ON state such that the parasitic device 106 is controlled to operate as a reflector, and the switch SW1 of the parasitic device 104 is in the ON state while the switch SW2 and SW3 of the parasitic device 104 is in the OFF state such that the parasitic device 104 is controlled to operation as a director, the radiation characteristic of the antenna apparatus 10 is obtained that the directivity is directed to a direction approaching the x direction as illustrated in FIG. 6B.

The example of the relationship between the functions of the parasitic devices 103 to 106 and the directivity has been described above. Also, the method of deflecting the radiation characteristic in the x direction or in the −xdirection through the control method (switching operation) of the parasitic devices 104 and 106 has been described with reference to FIGS. 4A to 6B. Further, the method of deflecting the radiation characteristic in the y direction or in the −y direction through the control of the parasitic devices 103 and 105 has been already described with reference to FIG. 3. Through the combination of the control methods, when the functions of the parasitic device 103-106 are simultaneously controlled, a bias of the radiation characteristic can be adjusted in the x-y plane and the directivity can be controlled two-dimensionally or three-dimensionally in the x-y-z axes.

According to the above-described configuration and operation of the antenna apparatus 100 to control the function (director/reflector) of the parasitic devices 103 to 106 disposed around the patch antenna 103 and to switch (change) the directivity, it is possible to switch (change) a direction of the directivity two-dimensionally (three-dimensionally) by the appropriate control method (switching operation) of the parasitic devices 103 to 106.

Since the parasitic devices 103 to 106 are configured of the metal wire and switches SW1, SW2, and SW3, it is possible to implement the miniaturized and height-lowered antenna apparatus 100. Therefore, it is possible to implement a small mobile communication base station capable of switching the directivity two dimensionally (three-dimensionally) by employing the configuration of the antenna apparatus 100 of FIGS. 1 through 6B.

Next, an antenna apparatus 200 according to an exemplary embodiment of the present general inventive concept will be described with reference to accompanying drawing.

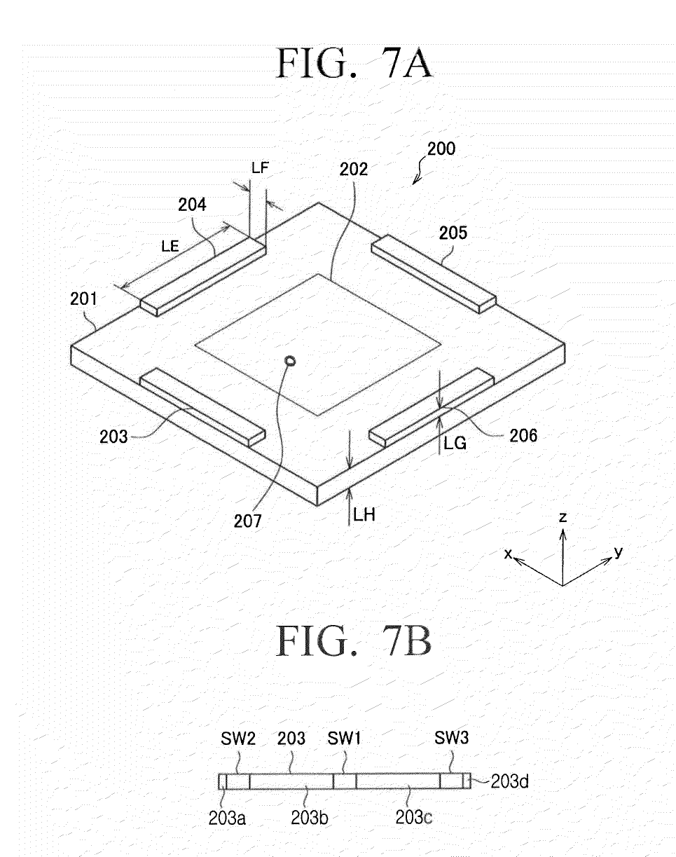

FIG. 7A is a perspective view illustrating the antenna apparatus 200 according to an exemplary embodiment of the present general inventive concept. As illustrated in FIG. 7A, the antenna apparatus 200 includes a ground conductor 201, a patch antenna 202, and a plurality of parasitic devices, such as parasitic devices 203, 204, 205, and 206. The parasitic devices 203, 204, 205, and 206 may be a non-power supply device. The parasitic devices 203 to 206 may perform functions thereof without power supply thereto. The parasitic devices 203 to 206 may be configured of a metal plate, for example, thin plates of a metal material laminated on the ground conductor 201 (a dielectric substrate). Accordingly, a conductor such as iron (Fe) or aluminum (Al) may be used as the ground conductor 201.

The patch antenna 202 may have a dimension and a shape, for example, a rectangular shape, and is disposed on the ground conductor 201. The patch antenna 202 may be installed on the ground conductor 201 via a spacer (not illustrated). In the patch antenna 202, a power supply point 207 is provided at a position in which a detection direction is regulated. Further, the patch antenna 102 is connected to the ground conductor 201 via the power supply point 207. The ground conductor 201 and the patch antenna 202 may have a dimension or size determined according to a design or preference. For example, the ground conductor 201 may be determined as a square in which one side has a length of 50 mm and the patch antenna 202 may be determined as a square in which one side has a length of 24.4 mm. A thickness of the ground conductor 201 may be set to 0.8 mm.

The parasitic devices 203 to 206 are disposed around each side of the patch antenna 202. Further, switches are provided on three locations, that is, approximately a central portion and both ends of each of the parasitic devices 203 to 206. For example, a configuration of the switch provided in the parasitic device 203 is illustrated in FIG. 7B. As illustrated in FIG. 7B, switches SW1, SW2, and SW3 are provided on three locations of the parasitic device 203. By an ON/OFF operation of the switches SW1, SW2, and SW3, an electrical length of the parasitic device 203 is switched (changed). For example, when the switch SW1 is in the OFF state, the parasitic device 203 is divided in the central portion thereof. That is, sections 203a, 203b, 203c, and 203d of the parasitic device 203 may be electrically disconnected or connected to one another according to the switching operation (control method).

Further, the same switches are provided on the parasitic devices 204 to 206. The switches SW1, SW2, and SW3 may be a switch having a mechanical contact point or a switch using a semiconductor device having no mechanical contact point.

A length LE of the parasitic devices 203 to 206 is set, for example, to about ½ (that is, λ/2) of a wavelength λ in a resonant frequency of the patch antenna 202. For example, the length LE may be set to 30 mm, a width LF is set to 3 mm, and a thickness LG is set to 1.6 mm. However, the dimension or arrangement of the parasitic devices 203 to 206 is not limited thereto and may be appropriately changed depending the resonant frequency of the patch antenna 202 or a size of the ground conductor 201.

Therefore, the directivity of the antenna apparatus 200 according to the exemplary embodiment may be switched (changed) by controlling the ON/OFF operation of the switches SW1, SW2, and SW3 provided on each of the parasitic devices 203 to 206. The parasitic device 203 to 206 may be changed to be operated as a director or a reflector and not to be operated as the director or reflector according to ON/OFF switching of the switches SW1, SW2, and SW3. Therefore, by changing a combination of a director function, a reflector function, or a non-director or non-reflector function of each of the parasitic devices 203 to 206, the directivity of the antenna apparatus 200 can be switched.

When the switches SW1, SW2, and SW3 all are in the OFF state, since the metal wires constituting the parasitic devices 203 to 206 are divided, the parasitic devices 203 to 206 are not operated as a director or a reflector. When the switch SW1 is the ON state and the switches SW2 and SW3 are in the OFF state, the central portion of the parasitic device is connected and both ends thereof are open-circuited, and an electrical length of the parasitic device becomes slightly shorter than λ/2. Therefore, the parasitic devices 203 to 206 are operated as a director. Meanwhile, when the switches SW1 to SW3 all are in the ON state, the electrical length of the metal wire becomes slightly longer than λ/2. Therefore, the parasitic devices 203 to 206 are operated as a reflector.

According to the above-described configuration of the antenna apparatus 200 the above-described switching operation of the parasitic devices 203 to 206 to operate as a director or reflector, it is possible to switch the directivity two dimensionally (three-dimensionally) through the control method (switching operation) of the switching transistors SW1, SW2, and SW3.

Further, since the parasitic devices 203 to 206 are configured of the laminated thin plates of the metal material and the switches SW1, SW2, and SW3, it is possible to implement the miniaturized and height-lowered antenna apparatus 200. Therefore, it is also possible to implement a small mobile communication base station capable of switching the directivity two dimensionally (three-dimensionally) by employing the configuration of the antenna apparatus 200.

Next, an antenna apparatus 300 according to an exemplary embodiment of the present general inventive concept will be described with reference to accompanying drawing.

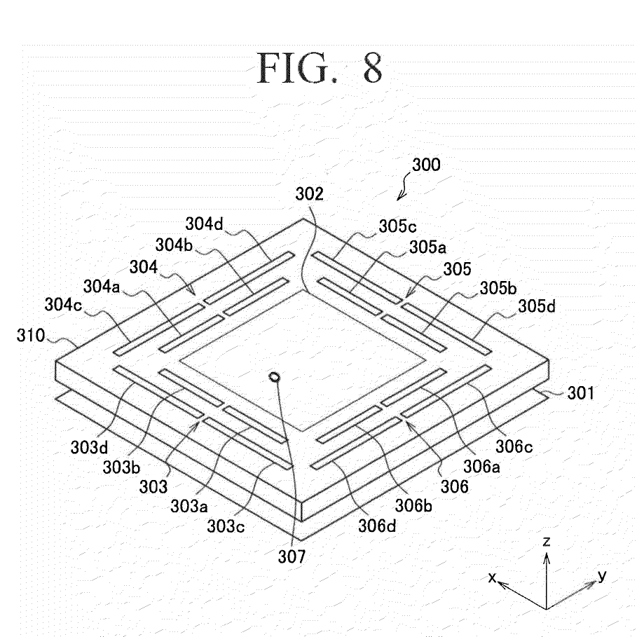

FIG. 8 is a perspective view illustrating the antenna apparatus 300 according to an exemplary embodiment. As illustrated in FIG. 8, the antenna apparatus 300 includes a ground conductor 301, a patch antenna 302, a plurality of parasitic devices, for example, parasitic devices 303, 304, 305, and 306, and a dielectric substrate 310.

The patch antenna 302 is disposed on the ground conductor 301. The patch antenna 302 may be installed on the ground conductor 301 via a spacer (not illustrated). The patch antenna 302 and the plurality of parasitic devices 303 to 306 are formed on the same surface of the dielectric substrate 310. The patch antenna 302 may have a predetermined shape, for example, a rectangular shape. In the rectangular patch antenna 302, a power supply point 307 is provided in the patch antenna 302 at a position in which a detection direction is regulated. Further, the patch antenna 302 is connected to the ground conductor 301 via the power supply point 307. The ground conductor 301 and the dielectric substrate 310 may have a dimension or size to be appropriately determined according to a size required to the antenna apparatus 300. For example, the ground conductor 301 and the dielectric substrate 310 may be set as a square in which one side has a length of 50 mm.

As illustrated in FIG. 8, the parasitic devices 303 to 306 are disposed around each side of the patch antenna. The parasitic device 303 includes inner patterns 303a and 303b and outer patterns 303c and 303d. Similarly, the parasitic device 304 includes inner patterns 304a and 304b and outer patterns 304c and 304d, the parasitic device 305 includes inner patterns 305a and 305b and outer patterns 305c and 305d, and the parasitic device 306 includes inner patterns 306a and 306b and outer patterns 306c and 306d. Further, the inner patterns are disposed at a position closer to a side of the patch antenna and the outer patterns are disposed at a position farther from the side.

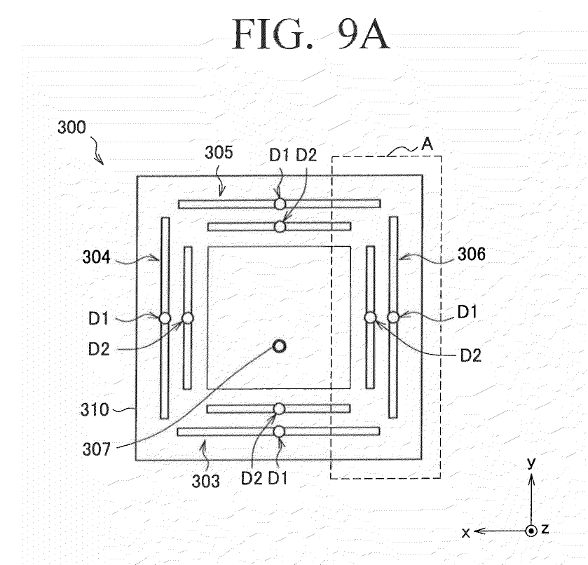

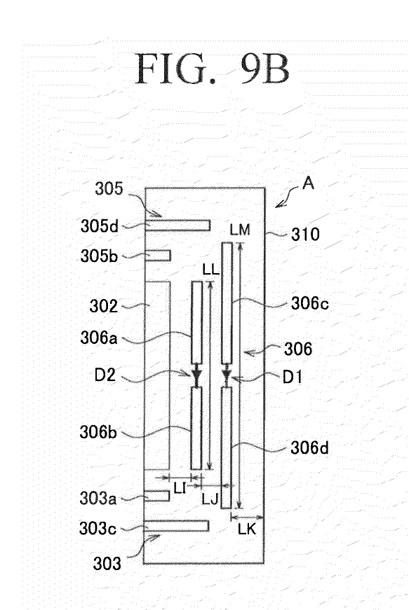

Here, the configuration of the parasitic devices 303 to 306 will be described in more detail with reference to FIGS. 9A and 9B. FIG. 9A is a plan view when viewed from top of the dielectric substrate 310. FIG. 9B is an enlarged view of a region A of FIG. 9A surrounded by a dotted line. The parasitic devices 303 to 306 have the same configurations as one another and thus only the parasitic device 306 illustrated in the enlarged view of FIG. 9B will be described in detail as one example.

The configuration of the inner patterns 306a and 306b and the outer patterns 306c and 306d will be described with reference to FIG. 9B. A direction close toward the patch antenna 302 is referred to as “inner side” and a direction farther from the patch antenna 302 is referred to as “outer side.”

The inner patterns 306a and 306b are disposed at a position spaced apart from a side of the patch antenna 302 by a distance LI. The outer patterns 306c and 306s are disposed at a position spaced apart from an outer side of the inner patterns 306a and 306b by the distance LJ. The distance between the outer patterns 306c and 306d and a side portion of the dielectric substrate 310 is denoted as LK. A length of a total inner pattern including the inner patterns 306a and 306b is denoted as LL and a length of a total outer pattern including the outer patterns 306c and 306d is denoted as LM.

In the parasitic device 306 according to the exemplary embodiment, a length of a sum of the length LL and the length LM may be set to about ½ (λ/2) of a wavelength λ of the resonant frequency of the patch antenna 302. The distances LI, LJ, and LK are appropriately determined according to the resonant frequency of the patch antenna 302 or a size of the dielectric substrate 310. For example, the distance LI is set to 2.3 mm, the distance LI is set to 3 mm, and the distance LK is set to 5 mm. In this case, the length LL is set to 28 mm and the length LK is set to 36 mm.

The inner patterns 306a and 306b are connected to each other through a diode D2. The diode D2 serves as a switch configured to switch electric connection/disconnection of the inner patterns 306a and 306b. Similarly, the outer patterns 306c and 306d are connected to each other through a diode D1. The diode D1 serves as a switch configured to switch electric connection/disconnection of the inner patterns 306c and 306c. Further, in FIG. 9A, the diodes D1 and D2 are indicated by circles. The diodes D1 and D2 are substantially provided for the functions of the respective parasitic devices 303 to 306 as illustrated in FIGS. 9A and 9B.

The antenna apparatus 300 according to the exemplary embodiment switches ON/OFF states of the diodes D1 and D2 to control the parasitic devices 303 to 306 to operate as the director and/or reflector so that the two-dimensional (2D) (three-dimensional (3D)) switching of the directivity is realized. Thus, the switching of the directivity is realized using the parasitic devices 303 to 306 including the inner patterns and the outer patterns so that the variable range in the directivity can widened and sharp directivity can be obtained.

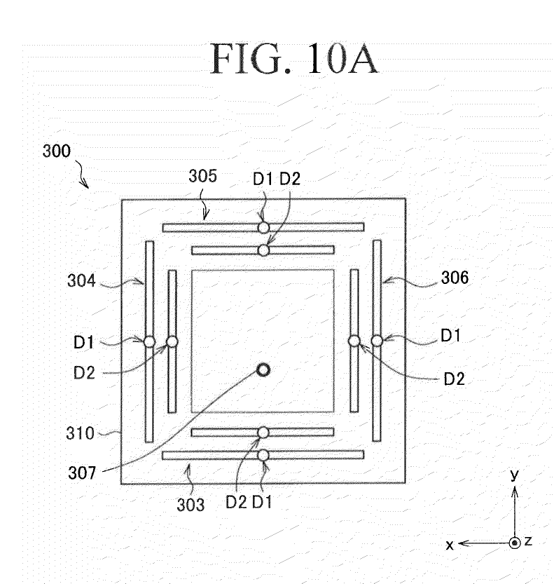

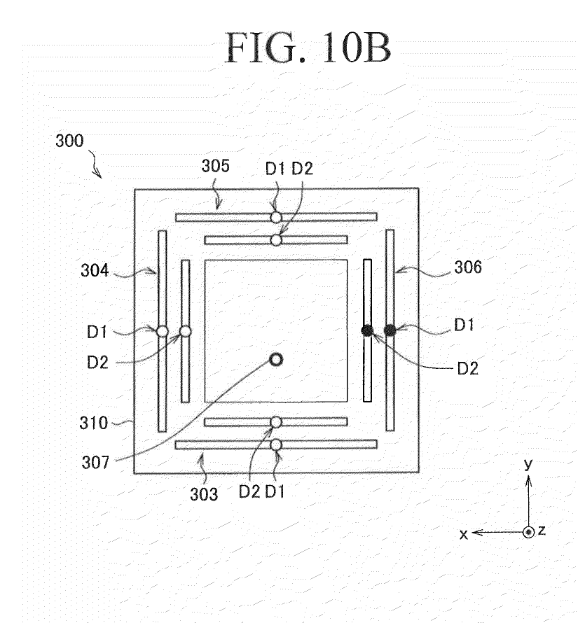

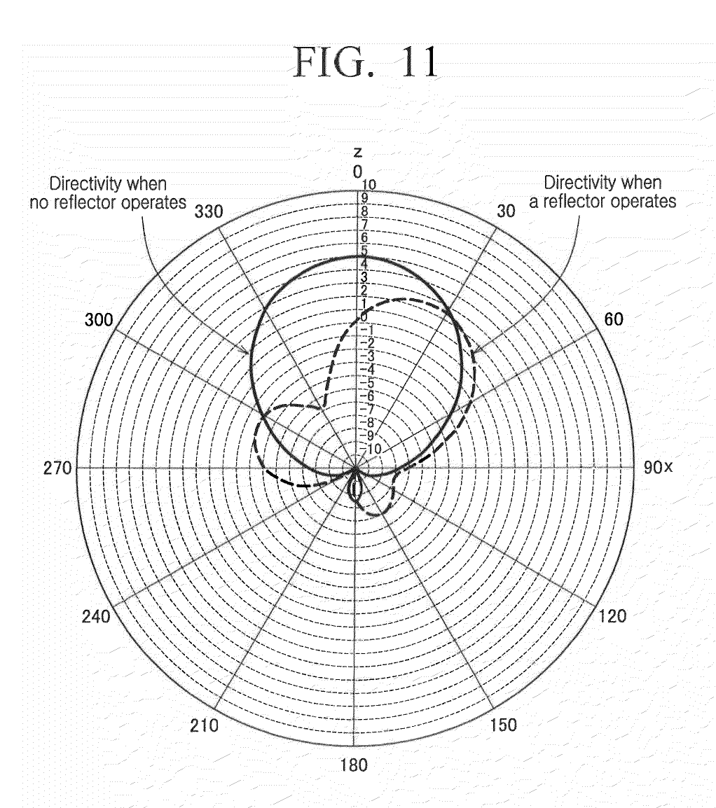

A relationship of the switching of the diodes D1 and D2 and variation of the directivity will be described with reference to FIGS. 10A, 10B, and 11. In FIGS. 10A and 10B, the diodes D1 and D2 are indicated by the circles. The ON state of the diode is indicated by a white circle and the OFF state of the diode is indicated by a black circle.

Since each pattern is electrically disconnected when all the diodes D1 and D2 for the parasitic devices 303 to 306 are in the OFF state as illustrated in FIG. 10A, the parasitic devices 303 to 306 is not operated as the reflector. Therefore, the directivity of the antenna apparatus 300 is directed to a front direction (z direction) in the three-dimensional direction. Meanwhile, as illustrated in FIG. 10B, when the diodes D1 and D2 of the parasitic device 306 are in the ON state and the diodes D1 and D2 of the parasitic devices 303, 304, and 306 are in the OFF state, an electrical length of the parasitic device 306 becomes slightly longer than λ/2. In this case, the parasitic device 306 is operated as a reflector and thus the directivity of the antenna apparatus 300 is directed to a direction approaching the x direction as in FIG. 11.

When the diodes D1 and D2 of the parasitic device 304 are in the ON state and the diodes D1 and D2 of the parasitic devices 303, 305, and 306 are in the OFF state, the parasitic device 304 is operated as a reflector and thus the directivity of the antenna apparatus 300 is directed to a direction approaching the −x direction. When the diodes D1 and D2 of the parasitic device 303 are in the ON state and the diodes D1 and D2 of the parasitic devices 304, 305, and 306 are in the OFF state, the parasitic device 303 is operated as a reflector and thus the directivity of the antenna apparatus 300 is directed to a direction approaching the y direction. Further, when the diodes D1 and D2 of the parasitic device 305 are in the ON state and the diodes D1 and D2 of the parasitic devices 303, 304, and 306 are in the OFF state, the parasitic device 305 is operated as a reflector and thus the directivity of the antenna apparatus 300 is directed to a direction approaching the −y direction.

Further, when the diodes D1 and D2 of the parasitic devices 303 and 304 are in the ON state and the diodes D1 and D2 of the parasitic devices 305 and 306 are in the OFF state, the parasitic devices 303 and 304 are operated as a reflector and thus the directivity of the antenna apparatus 300 is directed to a direction approaching the −x and y directions. As described above, the diodes D1 and D2 of any one or two of the parasitic device 303 to 306 are in the ON state and the diodes D1 and D2 of the other parasitic diodes are in the OFF state, the directivity of the antenna apparatus 300 is freely switched two-dimensionally (three-dimensionally).

According to the above-described configuration and operation of the antenna apparatus 300 which is configured that the patch antenna 302 and the parasitic devices 303 to 306 are disposed on the same surface of the dielectric substrate 310, a total height of the antenna apparatus 300 can be more reduced as compared to the above-described antenna apparatuses 100 and 200. Therefore, it is possible to implement a small mobile communication base station mounted with the antenna apparatus 300. Although the diode is not used as a switch in the antenna apparatus 300, a semiconductor switch or a micro-electro-mechanical system (MEMS) switch may be used as the switch of the antenna apparatus 300.

In the patch antennas 102, 202, and 302, positions of the power supply points are changeable such that a polarized wave can be switched. For example, other power supply points are arranged at positions in which the power supply points 107, 207, and 307 are rotated by a predetermined degree, for example, 90° on the basis of the patch antennas 102, 202, and 302. In this case, a using power supply point of two power supply points is switched to vary the polarized wave.

Hereinfter, an antenna apparatus 400 according to an exemplary embodiment of the present general inventive concept will be described with reference to accompanying drawing.

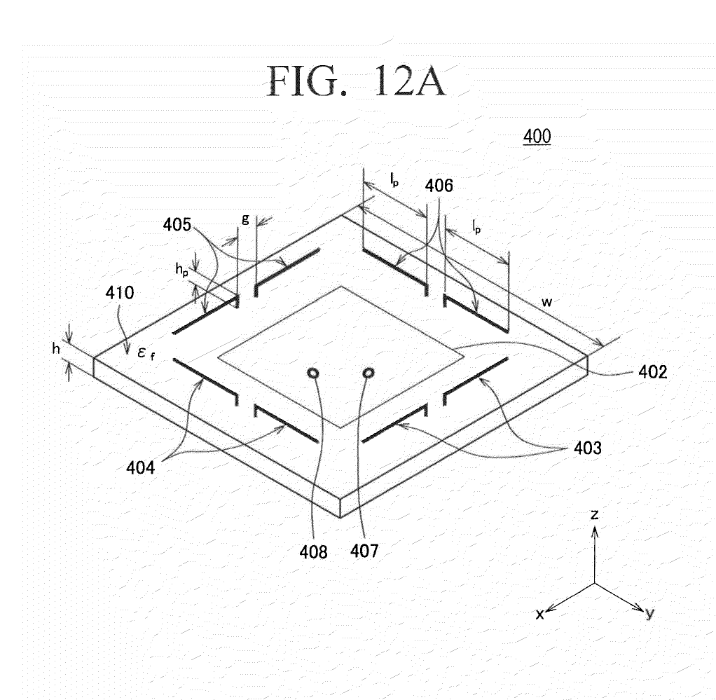

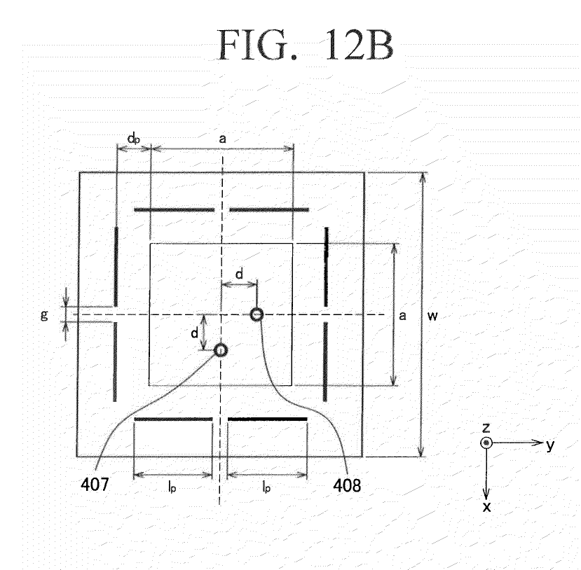

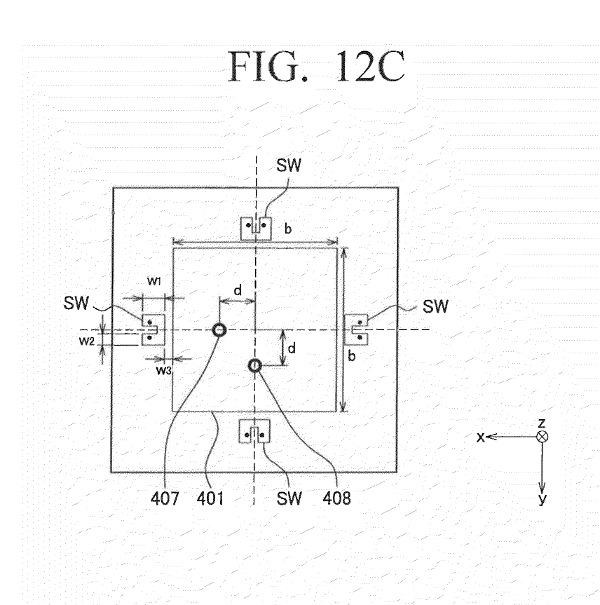

FIGS. 12A to 12C are views illustrating the antenna apparatus 400 according to the exemplary embodiment of the present general inventive concept. FIG. 12A is a perspective view, FIG. 12B is a top view, and FIG. 12C is a bottom view. As illustrated in FIGS. 12A and 12B, the antenna apparatus 400 includes a patch antenna 402, a plurality of parasitic devices, for example, parasitic devices 403, 404, 405, and 406, and a dielectric substrate 410. The patch antenna 402 may have a predetermined shape, for example, a rectangular shape. In the rectangular patch antenna 402, power supply points 407 and 408 are provided at a position in which a detection direction is regulated. As illustrated in FIG. 12C, a ground conductor 401 is provided on a rear surface of the dielectric substrate 410. The parasitic devices 403 to 406 each have two or more sections having a gap G therebetween. Each section may be configured of an L-shape. The parasitic devices 403 to 406 may be a metal wire. Fe or Al may be used as the metal wire of the parasitic devices 403 to 406.

The patch antenna 402 has a rectangular shape and is disposed on the dielectric substrate 310. The patch antenna 402 is connected to the ground conductor 401 through the power supply points 407 and 408. Further, the dielectric substrate 410 is disposed on the ground conductor 401. The dielectric substrate 410 may be installed on the ground conductor 401 via a spacer (not illustrated). The patch antenna 402 and the parasitic devices 403 to 406 are disposed on the same surface of the dielectric substrate 410. The ground conductor 401, the patch antenna 402, and the dielectric substrate 410 may have a dimension and size to be appropriately set according to a size required to the antenna apparatus 400.

As illustrated in FIG. 12A, the parasitic devices 403 to 406 are disposed around each side of the patch antenna 402. Each of the parasitic devices 403 to 406 is configured of two L-shaped metal wires. One end of the L-shaped metal wire penetrates the dielectric substrate 410 and is connected to a switch SW provided on the rear surface of the dielectric substrate 410 as illustrated in FIG. 12C. The one ends of the two L-shaped metal wires are connected to the switch SW. For example, the two L-shaped metal wires constituting the parasitic devices 403 are connected to the same switch SW provided on the rear surface of the dielectric substrate 410. This configuration is applied to the parasitic devices 404, 405, and 406.

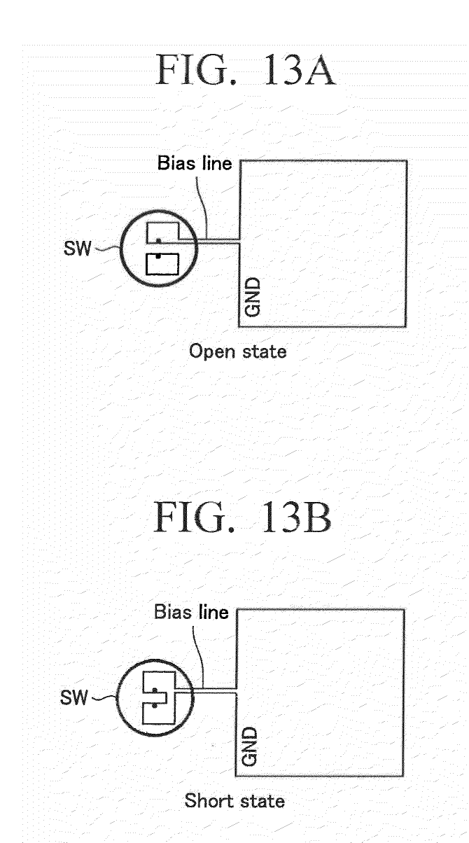

The switch SW is connected to the ground conductor 401 via a bias line as illustrated in FIGS. 13A and 13B. A bias is supplied to the switch SW via the bias line. FIG. 13A illustrates an open-circuit state of the switch SW and FIG. 13B illustrates a short-circuit state of the switch SW. When the switch SW is short-circuited, the two L-shaped metal wires are electrically connected. When the switch is open-circuited, the two L-shaped metal wires are electrically disconnected. Therefore, it is possible to vary the electrical lengths of the parasitic devices 403 to 406 through the open-circuit/short-circuit of the switch SW.

Lengths (a sum of long side LPx2 and short side LPx2 in FIG. 12A) of the parasitic devices 403 to 406 is set, for example, to about a half (that is, λ/2) of a wavelength λ in a resonant frequency of the patch antenna 402. Therefore, the functions of the parasitic devices 403 to 406 can be switched (changed) through the open-circuit/short-circuit of the switch SW. For example, when the switch SW of the parasitic device 403 is short-circuited to electrically connect the metal wires of the parasitic device 403, the parasitic device serves as a reflector. When the switch SW of the parasitic device 403 is open-circuited to electrically disconnect the metal wires of the parasitic device 403, the parasitic device is divided into two L-shaped metal wires sufficiently shorter than λ/2 and thus does not serve as a reflector. These configuration and switching operation are applied to the parasitic devices 404, 405, and 406.

As described above, the antenna apparatus 400 can freely switch the functions of the parasitic devices 403 to 406. Therefore, a combination of the parasitic devices 404 to 406 serving as the reflector is appropriately selected so that the directivity can be freely switched. Further, a polarized wave can be variable using the switching of the power supply points 407 and 408.

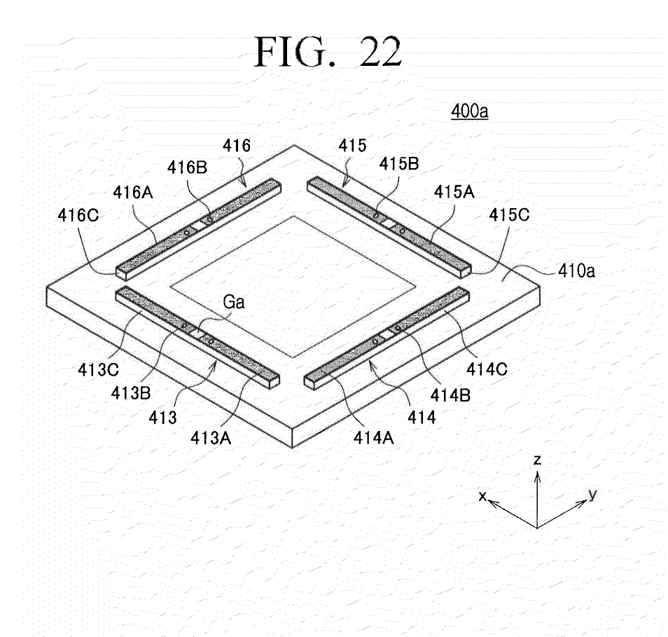

Hereinafter, a variant of the antenna apparatus 400 according to the exemplary embodiment of the present general inventive concept will be described with reference to FIG. 22.

Although the parasitic devices 403 to 406 formed of the L-shaped metal wire has been described, the parasitic devices 403 to 406 may be formed of other materials other than the metal wire. For example, the configuration of the antenna apparatus 400 may be modified into a configuration illustrated in FIG. 22. Further, substantially the same configurations as that of the antenna apparatus 400 illustrated in FIG. 12A will be omitted in FIG. 22. For example, the configuration of the power supply points 407 and 408 or the switch SW provided on the rear surface of the dielectric substrate 410 is omitted.

As illustrated in FIG. 22, an antenna apparatus 400a includes parasitic devices 413, 414, 415, and 416. The parasitic device 413 includes a metal foil 413A, a through hole 413B, and a dielectric substrate 413C. The dielectric substrate 413C substantially has a rod-shaped extending in a predetermined direction and may be installed in a main dielectric substrate 410a. The dielectric substrate 413C may be integrally formed with the main dielectric substrate 410 in a monolithic body. In this case, a convex portion of the main dielectric substrate 410a may be used as the dielectric substrate 413C.

The metal foil 413A having a predetermined length is attached to an upper surface of the dielectric substrate 413C from each end of the dielectric substrate 413C toward a central portion thereof. That is, two sheets of metal foils are provided on the dielectric substrates 413C, the length of the metal foil 413A is set so that a total length of the two sheets of metal foils 413A is set to be slightly longer than ½ (λ/2) of the wavelength λ in the resonant frequency of the patch antenna 402.

The through hole 413B, which is contactable to the switch SW (FIG. 12C) provided in the rear surface of the dielectric substrate 410 and penetrates the metal foil 413A, the dielectric substrate 413C, is provided at a location close to the central portion of the dielectric substrate 413C. The metal foil 413A is connected to the switch SW provided in the rear surface of the dielectric substrate 410 through the through hole 413B. The two sheets of metal foils 413A are configured that each of the two sheets of metal foils 413A is connected to the switch SW illustrated in FIG. 12C and the electrical connection state of the two sheets of the metal foils 413A can be controlled by the switching the open-circuit/short-circuit of the switch SW. Although the two sheets of metal foil 413A may be spaced apart from each other by a gap G, the two sheets can be electrically connected or disconnected according to a switching operation of the switch SW.

As described above, since a total length including the two sheets of metal foils 413A is set to be slightly longer than ½ (λ/2) of the wavelength λ in the resonant frequency of the patch antenna 402, the function of the parasitic device can be switched according to the open-circuit/short-circuit of the switch SW. For example, when the switch SW of the parasitic device 403 is short-circuited, the parasitic device 413 serves as a reflector. When the switch SW of the parasitic device 403 is open-circuited, the parasitic device 413 does not serve as a reflector. The control method of the function and the principle thereof are the same as those in the antenna apparatus 400 illustrated in FIG. 12A. Further, the configuration and operation of the parasitic device 413 can be applied to the parasitic devices 414, 415, and 416.

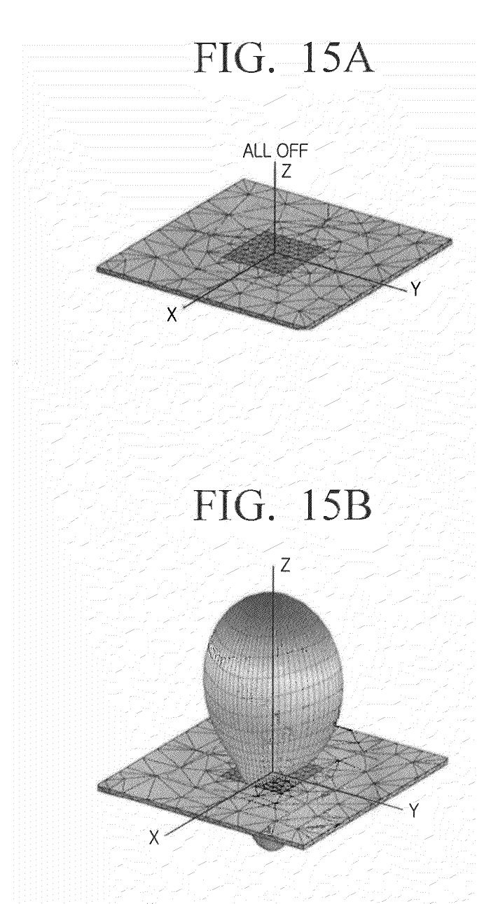

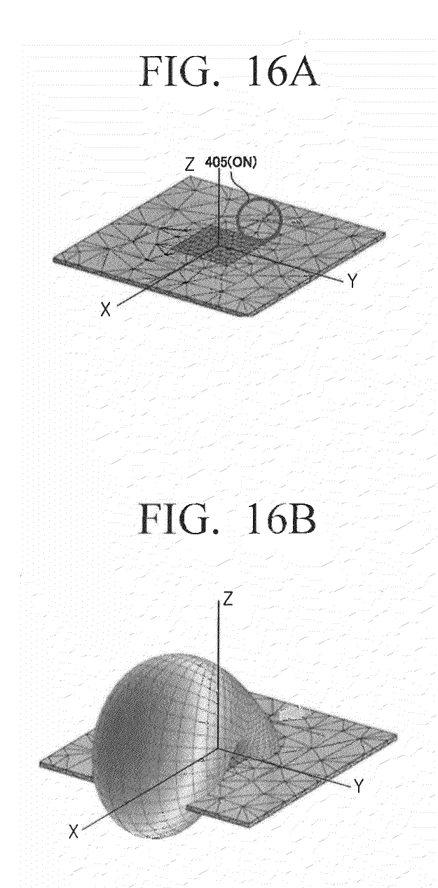

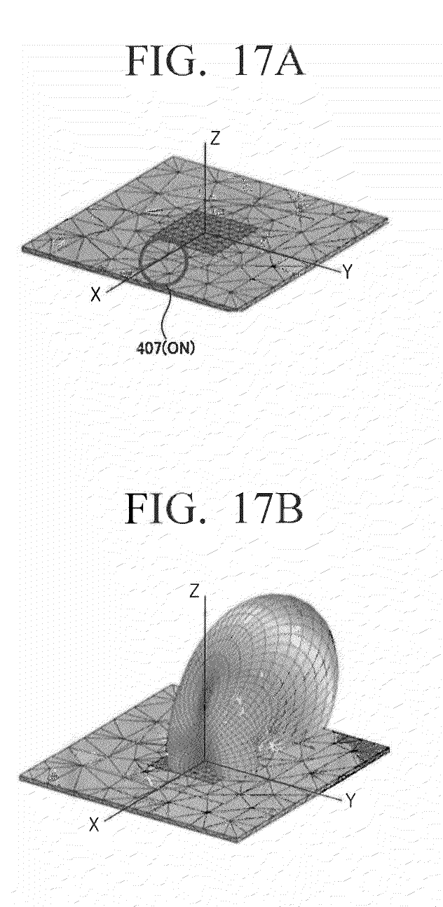

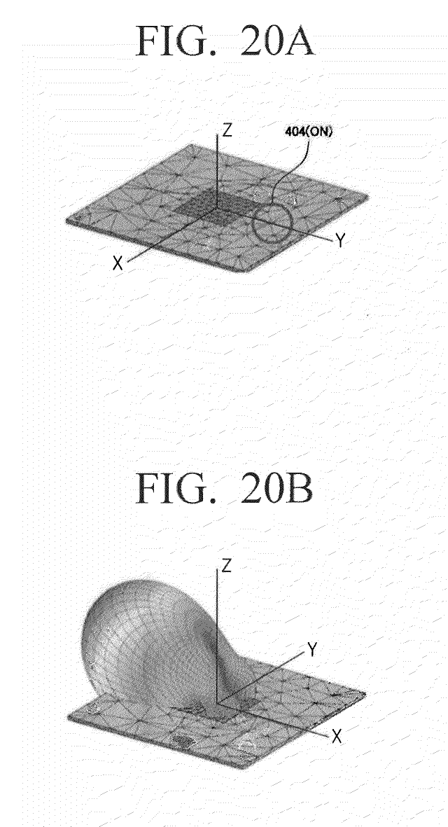

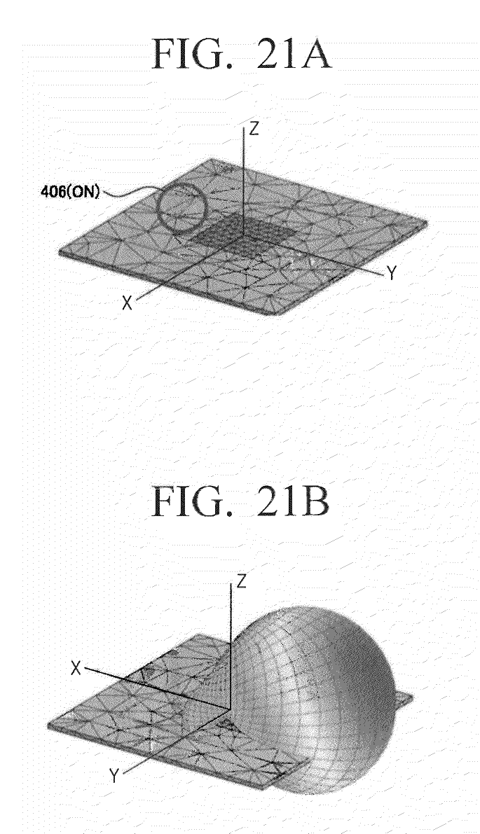

Therefore, in a state in which all switches SW of the parasitic devices 413, 414, 415, and 415 are open-circuited, the radiation characteristic illustrated in FIG. 15A can be obtained. In a state in which the switch SW of the parasitic device 415 is short-circuited, the radiation characteristic illustrated in FIG. 16B can be obtained. In a state in which the switch SW of the parasitic device 417 is short-circuited, the radiation characteristic illustrated in FIG. 17B can be obtained. In a state in which the switch SW of the parasitic device 414 is short-circuited, the radiation characteristic illustrated in FIG. 20B can be obtained. In a state in which the switch SW of the parasitic device 416 is short-circuited, the radiation characteristic illustrated in FIG. 21B can be obtained. Further, a polarized wave can be also variable through the switching operation of the using power supply points 407 and 408.

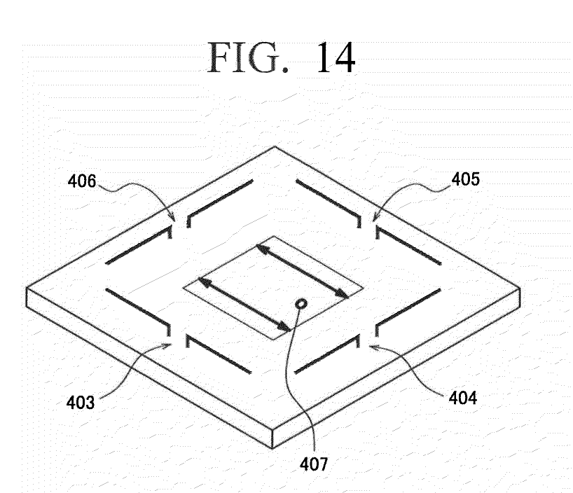

Next, an operation and a radiation characteristic of the antenna apparatus 400 according to the present general inventive concept will be described with reference to FIGS. 14 to 22. Further, simulation results illustrated in FIGS. 15A, 16A, 17A, 18A, 19A, 20A, and 21A can be calculated from the following conditions (see FIGS. 12A to 12C). hp=1.4 mm, h=1.6 mm, w=80 mm, ∈=4.8 (permittivity), a=23.6 mm, d=4.5 mm, Ip=23.1 mm, dp=12.5 mm, g=1.0 mm, b=33.0 mm, w1=3.0 mm, w2=2.0 mm, w3=5.8 mm.

An operation and a radiation characteristic of the antenna apparatus 400 will be reviewed with reference to FIGS. 14 to 17B. Here, FIG. 14 illustrates a change in the radiation characteristic when the parasitic devices 403 and 405 are controlled using the power supply point 407 with arrow directions.

As illustrated in FIG. 15A, when all switch SW of the parasitic devices 403 to 406 are open-circuited (in an OFF state), all the parasitic devices 403 to 406 do not serve as the reflector. Therefore, the directivity of the antenna apparatus 400 is directed to the front direction (z direction) as illustrated in FIG. 15B. Meanwhile, as illustrated in FIG. 16A, when the switch SW of the parasitic device 405 is short-circuited (in an ON state) and the switches SW of the parasitic devices 403, 404, and 406 are open-circuited, the parasitic device 405 serves as the reflector. Therefore, the directivity of the antenna apparatus 400 is directed to a direction approaching the y direction as illustrated in FIG. 16B. Further, as illustrated in FIG. 17A, when the switch SW of the parasitic device 403 is short-circuited and the switches SW of the parasitic devices 404, 405, and 406 are open-circuited, the parasitic device 403 serves as the reflector. Therefore, the directivity of the antenna apparatus 400 is directed to a direction approaching in the −y direction as illustrated in FIG. 17B.

### (Radiation Characteristic #2)

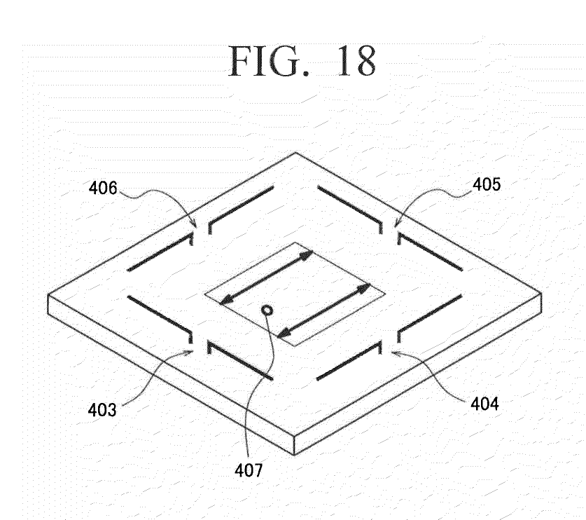

First, an operation and a radiation characteristic of the antenna apparatus 400 will be reviewed with reference to FIGS. 18 to 21B. Here, FIG. 18 illustrates a change in the radiation characteristic when the parasitic devices 404 and 406 are controlled using the power supply point 408 with arrow directions.

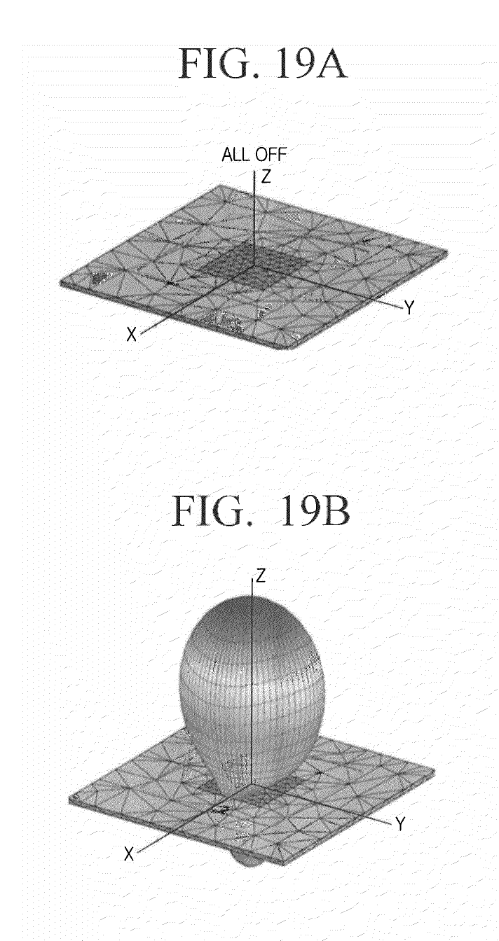

As illustrated in FIG. 19A, when all switch SW of the parasitic devices 403 to 406 are open-circuited, all the parasitic devices 403 to 406 do not serve as the reflector. Therefore, the directivity of the antenna apparatus 400 is directed to the front direction (z direction) as illustrated in FIG. 19B. Meanwhile, as illustrated in FIG. 20A, when the switch SW of the parasitic device 404 is short-circuited and the switches SW of the parasitic devices 403, 405, and 406 are open-circuited, the parasitic device 404 serves as the reflector. Therefore, the directivity of the antenna apparatus 400 is directed to a direction approaching the −x direction as shown in FIG. 20B. Further, as illustrated in FIG. 21A, when the switch SW of the parasitic device 406 is short-circuited and the switches SW of the parasitic devices 403, 404, and 405 are open-circuited, the parasitic device 406 serves as the reflector. Therefore, the directivity of the antenna apparatus 400 is directed to a direction approaching in the x direction as illustrated in FIG. 21B.

As described above, an antenna apparatus includes at least two pairs of parasitic devices, and the pairs are disposed on different directions with respect to a patch antenna.

It is possible that the pair of the antenna apparatus can be formed with one of the pair of the parasitic devices 103, 104, 105, and 106 of FIG. 1A, the pair of the parasitic devices 203, 204, 205, and 206 of FIG. 7A, the pair of the parasitic devices 303, 304, 305, and 306 of FIG. 8, the pair of the parasite devices 403, 404, 405, and 406 of FIG. 12A, and the pair of the parasitic devices 413, 414, 415, and 416 of FIG. 22. It is also possible that the pair of the antenna apparatus can be formed with a combination of one of the parasitic devices 103, 104, 105, and 106 of FIG. 1A, one of the parasitic devices 203, 204, 205, and 206 of FIG. 7A, one of the parasitic devices 303, 304, 305, and 306 of FIG. 8, one of the parasite devices 403, 404, 405, and 406 of FIG. 12A, and one of the parasitic devices 413, 414, 415, and 416 of FIG. 22.

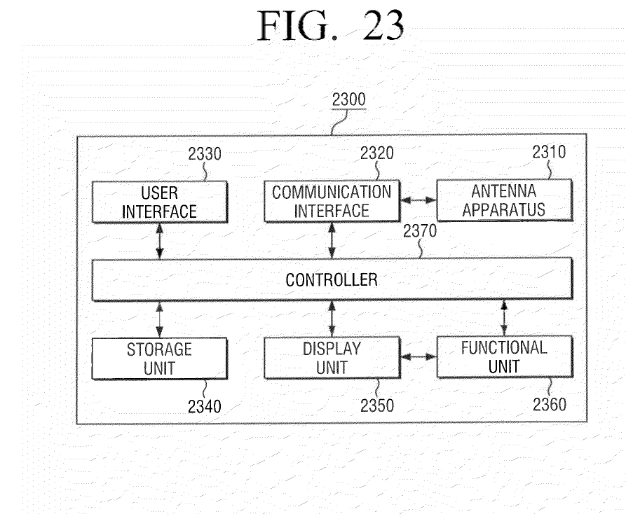

FIG. 23 illustrates a wireless communication apparatus 2300 according to an exemplary embodiment of the present general inventive concept. The wireless communication apparatus 2300 may be a mobile phone, a tablet apparatus, a wireless computer, an audio and/or video processing apparatus or an image forming apparatus, etc. The wireless communication apparatus 2300 may include an antenna apparatus 2310, a communication interface unit 2300, a user interface unit 2330, a storage unit 2340, a display unit 2350, a functional unit 2360, and a controller 2370.

The antenna apparatus 2310 may have the same configuration and operation as the antenna apparatus illustrated in FIGS. 1 through 22. The communication interface unit 2320 may control the antenna apparatus 2310 and may include a converting unit to provide a witching operation on parasitic devices, one or more power supply points, and/or a patch antenna of the antenna apparatus 2310 as described with reference to FIGS. 1 through 22. The converting unit may be included in the antennal apparatus 2310 and may include switches of each parasitic device. The converting unit generates switching signals to perform a switching operation to electrically connect or disconnect sections of each of the parasitic devices and also control the power supply points and patch antenna such that directivity can be switched or changed. The communication interface unit 2320 may also process signals to be transmitted or receive through the antenna apparatus 2310. The user interface unit 2330 may provide a user interface to be displayed on a display screen of the display unit 2350 and to receive command or data from a user. The display unit 2350 may be a touch panel to display the user interface and to receive user command and data through the user interface. The user interface unit 2330 and the display unit 2350 may be formed in a single unit. The storage unit 2340 may include a volatile memory unit and/or a non-volatile memory unit to store programs and data to perform functions of the wireless communication apparatus 2300.

The functional unit 2360 may process data stored in the storage unit 2340 or received from an external device through the antenna apparatus 2310 or process data to be stored in the storage unit 2340 or to be transmitted to an external device through the antenna apparatus 2310. The process data of the functional unit 2360 may be displayed on the display unit 2350 as an image. The controller 2300 may control the above described antenna apparatus 2310, communication interface unit 2300, user interface unit 2330, storage unit 2340, and functional unit 2360. The wireless communication apparatus 2300 may have additional units (not illustrated) installed therein or connected thereto through a terminal to perform additional functions of the wireless communication apparatus 2300. For example, the additional unit may be an audio unit to generate an audio signal according to the process data in the functional unit 2360.

According to the relationship between the functions of the parasitic devices 403 to 406 and directivity, a method of deflecting the radiation characteristic in the y direction or in the −y direction, and a method of deflecting the radiation characteristic in the x direction or the −x direction, the directivity can be freely switched in an x-y plane or in x-y-z three coordinates.

According to the configuration and operation of the antenna apparatus 400 such that the directivity is switched through the control method of the function of the parasitic devices 403 to 406 disposed around the patch antenna 402 as the reflector, the variable direction of the directivity can be two-dimensionally switched by appropriately controlling the parasitic devices 403 and 405 disposed to face each other along the y direction and the parasitic devices 404 and 406 disposed to face each other along the x direction.

As described above, the parasitic devices 403 to 406 are configured of the L-shaped metal wire and the switch SW provided in the rear surface of the dielectric substrate 410 and thus it is possible to realize a height-reduced and small-sized antenna apparatus 400. Therefore, it is possible to realize a small-sized mobile communication base station capable of 2D switching of the directivity employing the configuration of the antennal apparatus 400.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An antenna apparatus, comprising:
a substantially rectangular patch antenna;
a plurality of parasitic devices each disposed around a corresponding side of the patch antenna; and
a converting unit configured to switch an electrical length of each of the plurality of parasitic devices, and to control the electric length to be switched such that the parasitic devices operate as a reflector.

2. The antenna apparatus of claim 1, wherein the converting unit is configured to switch the electrical length such that the parasitic devices operate as a director.

3. The antenna apparatus of claim 1, wherein each of the parasitic devices is configured of a metal wire having one long side substantially parallel to one side of the patch antenna and two short sides, one end of each of the short sides is connected to an end of the long side and the other end thereof is a ground conductor.

4. The antenna apparatus of claim 3, wherein:
the converting unit includes a first switch provided around a center portion of the long side and configured to divide the long side in an OFF state and two second switches configured to divide the short sides in the OFF state; and
in a state in which the first and second switches are an ON state, the length of the metal wire is longer than a length of a half of a wavelength in a resonant frequency of the patch antenna, and in a state in which the first switch is the ON state and the second switches are in the OFF state, the length of the metal wire is shorter than the length of the half of the wavelength in the resonant frequency of the patch antenna.

5. The antenna apparatus of claim 1, wherein:
the parasitic device sets a direction substantially parallel to one side of the patch antenna as a longitudinal direction and is formed of a conductive thin plate laminated on a dielectric substrate in which the patch antenna is installed; and
the converting unit is formed on a central portion of the conductive thin plate.

6. The antenna apparatus of claim 5, wherein:
the converting unit is a switch configured to divide the conductive thin plate in the OFF state; and
in an ON state of the switch, the length of the conductive thin plate is longer than a length of a half of a wavelength in a resonant frequency of the patch antenna.

7. The antenna apparatus of claim 1, wherein:
each of the parasitic devices includes:
a first conductive thin plate in which a direction substantially parallel to one side of the patch antenna is set to a longitudinal direction, and
a second conductive thin plate which is disposed farther the one side of the patch antenna than the first conductive thin plate and in which a direction substantially parallel to the one side of the patch antenna is set to a longitudinal direction; and
the converting unit is formed in a central portion of the conductive thin plate.

8. The antenna apparatus of claim 7, wherein:
the converting unit is a switch configured to divide the conductive thin plate in the OFF state; and
in an ON state of the switch, the length of the conductive thin plate is longer than a length of a half of a wavelength in a resonant frequency of the patch antenna.

9. The antenna apparatus of claim 1, wherein the parasitic device is connected to the converting unit penetrating a dielectric substrate, in which the patch antenna is installed, and provided on a rear surface of the dielectric substrate.

10. The antenna apparatus of claim 9, wherein:
each of the parasitic devices is configured of a metal material extending in a direction according to each side of the patch antenna and including two portions electrically divided; and
the portions of the metal material are connected to the converting unit penetrating a dielectric substrate, in which the patch antenna is installed, and provided on a rear surface of the dielectric substrate.

11. The antenna apparatus of claim 10, wherein the metal material includes a metal foil or an L-shaped metal wire.

12. The antenna apparatus of claim 10, wherein:
the converting unit is a switch configured to connect the two portion of the metal material in an ON state and divide the two portions of the metal material in an OFF state,
a total length of the two portion of the metal material is longer than a length of a half of a wavelength of a resonant frequency of the patch antenna.

13. The antenna apparatus of claim 1, further comprising:
a plurality of power supply points,
wherein a polarized wave is varied by switching the power supply point in use.

14. A wireless communication apparatus comprising an antenna apparatus and a control unit configured to control the antenna apparatus, the antenna apparatus including:
a substantially rectangular patch antenna;
a plurality of parasitic devices each disposed around a corresponding side of the patch antenna;
a converting unit configured to switch an electrical length of each of the plurality of parasitic devices, and to control the electric length to be switched such that the parasitic devices operate as a reflector or a director.

15. An antenna apparatus, comprising:
a patch antenna;
a plurality of parasitic devices disposed around the patch antenna; and
a converting unit configured to change an electrical length of each of the plurality of parasitic devices with respect to a resonant frequency of the patch antenna to control the parasitic devices to operate one of a reflector and a director to affect directivity of the patch antenna.

16. The antenna apparatus of claim 15, wherein:
the patch antenna comprises a plurality of sides; and
the plurality of parasitic devices are disposed corresponding sides of the patch antenna.

17. The antenna apparatus of claim 15, wherein:
each of the plurality of parasitic devices includes a plurality of sections; and
the converting unit electrically connects or disconnects the adjacent sections of the parasitic device to control the parasitic devices to operate as the reflector or the director.

18. The antenna apparatus of claim 15, wherein the plurality of parasitic devices comprises:
a first pair of at least two parasitic devices disposed opposite to each other in a first direction with respect to the patch antenna; and
a second pair of at least two parasitic devices disposed opposite to each other in a second direction with respect to the patch antenna.

19. The antenna apparatus of claim 15, wherein the plurality of parasitic devices comprises one of a metal wire having a center portion spaced apart from a dielectric substrate and two ends extended from the center portion and disposed on the dielectric substrate, a laminated thin plate disposed on the dielectric substrate, a metal wire having a potion spaced apart from the dielectric substrate and one end extended from the portion and disposed on the dielectric substrate, and a metal foil disposed on a protruding portion of the dielectric substrate.

20. A wireless communication apparatus comprising the antenna apparatus of claim 15, a functional unit to process data received from an external device through the antenna apparatus or transmitted to the external device through the antenna apparatus, and a controller to control the functional unit and the antenna apparatus.
